(19) United States
(12) Patent Application Publication
(10) Pub. No.: US 2026/0310219 A1
(43) Pub. Date: Oct. 8, 2026

(54) SMART LOGISTICS VEHICLE CONTROL METHOD AND CONTROL DEVICE

(71) Applicants: Hyundai Motor Company, Seoul (KR); Kia Corporation, Seoul (KR)

(72) Inventors: Beom Jun LEE, Gyeonggi-do (KR); Kyung Dong PARK, Gyeonggi-do (KR); Kye Un AHN, Gyeonggi-do (KR); Sang Won YOON, Gyeonggi-do (KR)

(21) Appl. No.: 19/484,845

(22) PCT Filed: Oct. 11, 2023
(86) PCT No.: PCT/KR2023/015618

§ 371 Date: Nov. 14, 2025

(30) Foreign Application Priority Data
Jun. 26, 2023 (KR) 10-2023-0081975

(51) Int. Cl. G05D 1/644; G05D 1/229; G05D 1/246; G05D 107/70; G05D 109/10; G06Q 10/08

(52) U.S. Cl. CPC G05D 1/644; G05D 1/229; G05D 1/246; G06Q 10/08; G05D 2107/70; G05D 2109/10

(57) ABSTRACT

is proposed, the method comprising: identifying a mission situation of a smart logistics vehicle; on the basis of map information in which different route selection-based scores are assigned to at least some virtual lanes within an operation boundary for each mission situation, determining a driving route so that the smart logistics vehicle moves along a virtual lane corresponding to the identified mission situation on the basis of a route selection-based score corresponding to the identified mission situation; and transmitting route information corresponding to the determined driving route to the smart logistics vehicle.

### TECHNICAL FIELD

The present disclosure relates to a smart logistics vehicle control method and a control device for providing information about a driving route according to mission performance of a smart logistics vehicle.

### BACKGROUND ART

In recent years, smart logistics vehicles have been introduced for flexible and efficient supply and transport of components and the like, not only in general logistics warehouses and factories, but also in operation boundaries (e.g., smart factories, etc.) that manufacture goods with specifications different from each other using various components.

The smart logistics vehicle is a concept collectively referring to an autonomous mobile robot (AMR) and an automated guided vehicle (AGV), and such a smart logistics vehicle can perform movements and operations under the control of a control system.

A virtual lane along which a smart logistics vehicle can travel may be formed in a certain region or zone on the operation boundary. Also, the control system may generate a driving route according to the mission performance for each smart logistics vehicle on the basis of the virtual lane formed in the operation boundary and may transmit the generated driving route to the smart logistics vehicle. However, the virtual lane formed in the operation boundary is not distinguished for each mission of the smart logistics vehicle, such that regions where the driving routes intersect or overlap may occur when generating the driving routes for the smart logistics vehicle.

In addition, when performing missions while moving along the driving route provided by the control system, the smart logistics vehicles may perform avoidance driving, such as reducing the driving speed of the smart logistics vehicle, in order to prevent collisions of smart logistics vehicles or the operation stopping of smart logistics vehicles due to the occurrence of sections where the driving routes intersect or overlap.

This may result in a problem of reducing the mobility of smart logistics vehicles on the operation boundary, and in order to prevent this, it is necessary to propose a plan to generate driving routes, in which mission-specific driving routes of smart logistics vehicles do not intersect or overlap, and provide the same to smart logistics vehicles.

The matters described above as the background technology are only intended to enhance an understanding of the background of the present disclosure, and should not be construed as acknowledging that it corresponds to the prior art already known to those skilled in the art.

### DISCLOSURE

### Technical Problem

The present disclosure is proposed to solve such a problem, and is intended to provide a smart logistics vehicle control method and a control device for providing information about a driving route according to mission performance of a smart logistics vehicle so that driving routes for different smart logistics vehicles with different missions to be performed do not intersect or overlap.

Technical tasks to be achieved by the present disclosure are not limited to the technical tasks mentioned above, and other technical tasks not mentioned may be clearly understood by those skilled in the art to which the present disclosure belongs from the following description.

### Technical Solution

A smart logistics vehicle control method according to the present disclosure for achieving the objective above includes identifying a mission situation of a smart logistics vehicle, determining a driving route on the basis of map information, where route selection-based scores different from each other are assigned to at least some of virtual lanes within an operation boundary for each mission situation, such that the smart logistics vehicle moves along the virtual lane corresponding to the identified mission situation on the basis of the route selection-based score corresponding to the identified mission situation, and transmitting route information corresponding to the determined driving route to the smart logistics vehicle.

In addition, a control device according to the present disclosure for achieving the objective above includes a map management unit for providing map information, where route selection-based scores different from each other are assigned to at least some of virtual lanes within an operation boundary for each mission situation, and a route selection unit for identifying the mission situation of a smart logistics vehicle, for determining a driving route on the basis of the map information provided by the map management unit, such that the smart logistics vehicle moves along the virtual lane corresponding to the identified mission situation on the basis of the route selection-based score corresponding to the identified mission situation, and for transmitting route information corresponding to the determined driving route to the smart logistics vehicle.

### Advantageous Effects

As described above, a smart logistics vehicle control method and a control device of the present disclosure can determine driving routes so that a smart logistics vehicle moves along a virtual lane corresponding to the identified mission situation on the basis of a route selection-based score corresponding to the identified mission situation, thereby preventing driving routes from intersecting or overlapping and improving the mobility of the smart logistics vehicle.

In addition, it is possible to easily identify the flow of logistics within an operation boundary by determining the driving route for each mission situation of the smart logistics vehicle.

The effects obtainable from the present disclosure are not limited to the effects mentioned above, and other effects not mentioned will be clearly understood by those skilled in the art to which the present disclosure belongs the description below.

### DESCRIPTION OF DRAWINGS

FIG. 1 is a block diagram illustrating an example of an operation boundary configuration applicable to exemplary embodiments of the present disclosure.

FIG. 2 is a block diagram illustrating an example of a control device configuration applicable to exemplary embodiments of the present disclosure.

FIG. 3 is a block diagram illustrating an example of a smart logistics vehicle configuration applicable to exemplary embodiments of the present disclosure.

FIG. 4 is a perspective view illustrating an example of an exterior appearance of a smart logistics vehicle applicable to exemplary embodiments of the present disclosure.

FIG. 5 is a flowchart illustrating an example of a driving process of a smart logistics vehicle applicable to exemplary embodiments of the present disclosure.

FIG. 6 is a view illustrating an operation boundary equipped with a control device according to an exemplary embodiment of the present disclosure.

FIGS. 7 to 10 are views illustrating a determination of a driving route of a smart logistics vehicle according to an exemplary embodiment of the present disclosure.

FIG. 11 is a view illustrating a smart logistics vehicle driving on the basis of route information according to an exemplary embodiment of the present disclosure.

FIG. 12 is a view illustrating a smart logistics vehicle control method according to an exemplary embodiment of the present disclosure.

### MODE FOR DISCLOSURE

In describing an exemplary embodiment disclosed in the present specification, the detailed description thereof may be omitted when it is determined that a detailed description of the related known technology may obscure the gist of the exemplary embodiment disclosed in the present specification. In addition, the accompanying drawings may be only intended to facilitate the understanding of the exemplary embodiment disclosed in the present specification, and the technical idea disclosed in the present specification may not be limited by the accompanying drawings and should be understood to include all modifications, equivalents, or substitutes included in the spirit and technical scope of the present disclosure.

Terms including ordinal numbers, such as a first and second, may be used to describe various components, but the components may not be limited by the terms. The terms may be used only for the purpose of distinguishing one component from another component.

When it is mentioned that a component is “connected” or “linked” to another component, it should be understood that the component may be directly connected or linked to the other component, but another component may be interposed therebetween. On the other hand, when it is mentioned that a component is “directly connected” or “directly linked” to another component, it should be understood that no other component exists in the middle.

Singular expressions may include plural expressions unless the context clearly indicates otherwise.

In the present specification, terms such as “include” or “have” may be intended to specify the existence of features, numbers, steps, operations, components, parts, or combinations thereof described in the specification, which should be understood not to preclude the existence or addition of one or more other features, numbers, steps, operations, components, parts, or combinations thereof.

Hereinafter, exemplary embodiments disclosed in the present specification will be described in detail with reference to the accompanying drawings, but identical or similar components will be assigned the same reference numbers regardless of the drawing codes, and redundant descriptions thereof will be omitted.

In addition, the terms, such as unit or control unit included in the names of internal configurations of a smart logistics vehicle or a control device are merely terms widely used to refer to controllers for controlling specific functions and do not refer to a generic function unit. For example, each controller may include a modem/transceiver for communicating with other control devices or sensors in order to control functions in charge, a memory for storing operating systems or logic commands and input/output information, and one or more processors for performing determination, calculation, and decision necessary to control functions in charge. Depending on implementations, one processor may be in charge of calculations for a plurality of control devices.

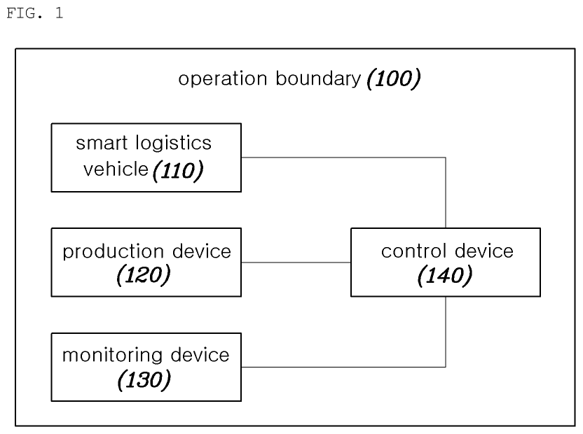

First, a configuration of an operation boundary in which a smart logistics vehicle is arranged and operated according to an exemplary embodiment will be described with reference to FIG. 1.

FIG. 1 is a block diagram illustrating an example of an operation boundary configuration applicable to exemplary embodiments of the present disclosure.

Referring to FIG. 1, an operation boundary 100 may include a smart logistics vehicle 110, a production device 120, a monitoring device 130, and a control device 140.

The operation boundary 100 may be equipped with a plurality of smart logistics vehicles 110, a plurality of production devices 120, and a plurality of monitoring devices 130 depending on a production process and a target production speed of a product. The operation boundary 100 may be implemented as a smart factory, but may not be limited thereto. Hereinafter, each component will be described.

First, the smart logistics vehicle 110 may include an autonomous mobile robot (hereinafter, referred to as an “AMR” for convenience) and an automated guided vehicle (hereinafter, referred to as an “AGV” for convenience). According to an operation policy of the smart logistics vehicle 110, only one type of either the AGV or the AMR may be operated within the operation boundary 100, or both the AGV and the AMR may be operated together within a single operation boundary 100.

The AGV may generally perform the operations (movement, direction change, stop, etc.) required within the operation boundary 100 by recognizing and following the guide facility arranged on the floor for guiding the AGV. Herein, the guide facility may refer to optically recognizable markers (spots, 2D codes, etc.), tags recognizable in a non-contact manner at a short distance (e.g., NFC tags, RFID tags, etc.), magnetic strips, wires, and the like, but this is illustrative and is not necessarily limited thereto. The guide facility may be arranged continuously on the floor or may be arranged to be discontinuously spaced apart from each other. Since the AGV basically performs operations by recognizing and following the guide facility, it is required that the guiding facility be installed in advance before operation, and it is necessary to physically establish or modify the guide facility when moving the AGV to a new route or modifying the existing route before operation. In addition, the AGV does not deviate from the route set through the guide facility, so it is common to stop when an obstacle is detected on or around the route until the detected obstacle is removed or separate control is provided. In the operation of the AGV, the control device 140 should control the AGV on the basis of the guidance facility, so may transmit the commands such as “driving until the third marker is recognized” and “switching the heading direction by 90 degrees when the third marker is recognized” to the AGV either as an individual command unit or as a mission unit (e.g., retrieval, supply, charging, patrol, etc.) including a plurality of commands.

The AMR may determine (i.e., positioning) the current location by detecting the surroundings, and the point, at which path planning is possible by using positioning and a map, may be the most distinguishing point from the AGV. Therefore, when the AMR and the control device 140 share a map in which coordinates are compatible with each other, the control device 140 may control the AMR in a manner of instructing the AMR a route on the basis of the coordinates. In addition, when detecting an obstacle while driving, the AMR may set an avoidance route on its own, avoid the obstacle, and return to the existing route. The function of setting the AMR route to one or more waypoint coordinates by the control device 140 may be referred to as global path planning, and the function of setting a movement route or an avoidance route between the waypoint coordinates according to the global path planning may be referred to as local path planning.

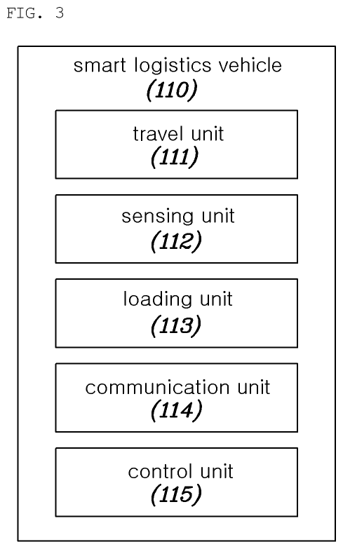

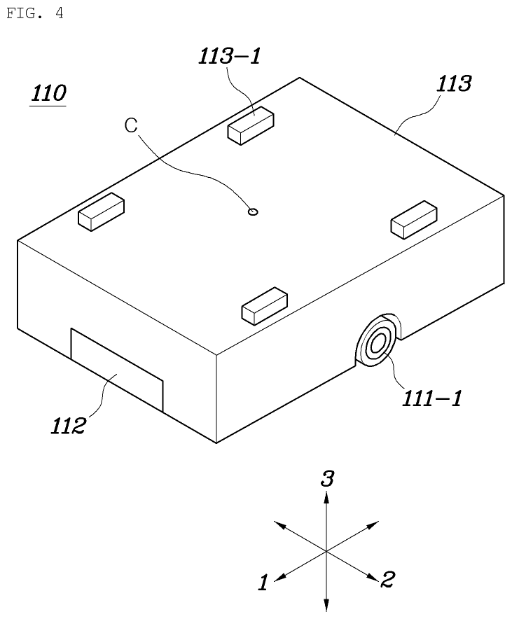

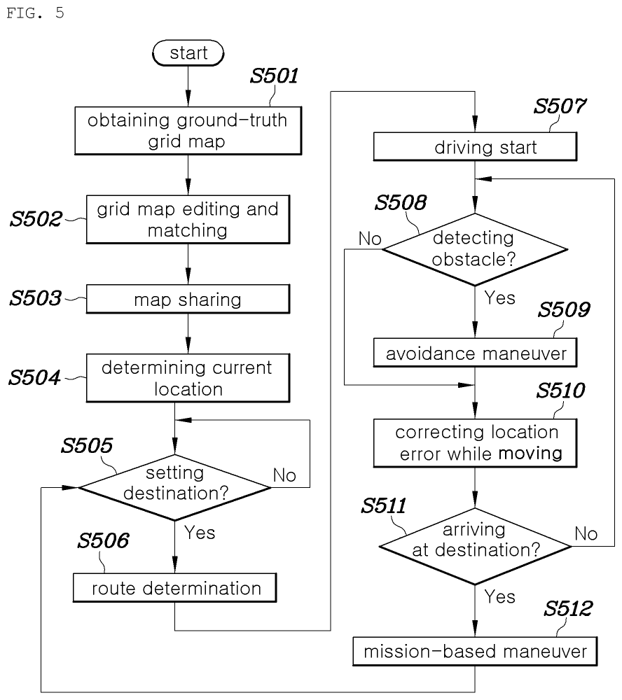

A more detailed configuration of the smart logistics vehicle 110 will be described later with reference to FIGS. 3 and 4, and a driving control process of the AMR will be described later with reference to FIG. 5, respectively.

Next, the production device 120 may refer to a device (e.g., robot arm, conveyor belt, etc.) that performs the production process of the product in the operation boundary 100 and, in a broader sense, may refer to a device arranged to assist in performing missions such as entry and exit of the smart logistics vehicle 110 when the production process is performed by a person. The device arranged to assist in performing missions may be a device for detecting the state of a designated location where a pallet carried by the smart logistics vehicle 110 can be put down or collected within a zone where a specific production process is performed, a device for determining the degree of the process progress, and a means for blocking entry and exit within a zone, etc., but is not necessarily limited thereto.

For example, the production device 120 may be controlled through a programmable logic controller (PLC) and can communicate with the control device 140 in relation to the process progress.

The monitoring device 130 may perform a function of obtaining information for determining a situation within the operation boundary 100 and transmitting the same to the control device 140. For example, the monitoring device 130 may include a camera, a proximity sensor, and the like, but may not be necessarily limited thereto.

The control device 140 may communicate with the aforementioned components 110, 120, 130 to obtain information necessary to operate the operation boundary 100 or control each component. For example, the control device 140 may perform dispatching, route setting, mission assignment, process management per product, material management, and the like of the smart logistics vehicle 110.

In implementations, the control device 140 may include a local control device (ACS: AMR/AGV Control System) for controlling surrounding process facilities on the basis of the locations of the AGVs/AMRs and performing mission-based control of the AGVs/AMRs, and an integrated control device (MoRIMS: Mobile Robot Integrated Monitoring System) for integrating and controlling two or more local control devices. The integrated control device may perform the state and route, logistics flow setting, and traffic control of all smart logistics robot 110 within the operation boundary 100 from each of the plurality of local control devices. For example, when the local control device (ACS) is equipped as smart logistics robot units of the same manufacturer or the same model, the integrated control device may perform integrated control for collision prevention, such as analysis of bottleneck levels in intersection/overlapping areas, driving acceleration/deceleration control, and regeneration of avoidance route, through heterogeneous traffic distribution control on the basis of information obtained through the plurality of local control devices (ACS).

Further, the integrated control device may have a manufacturing execution system (MES) as a higher-level control entity, and the manufacturing execution system (MES) may be again linked to the advanced planning & scheduling (APS).

In addition to the configurations 110, 120, 130, 140 of the aforementioned operation boundary 100, it is obvious that a device for intercommunication between components such as beacons, repeaters, APS (Access Point), a charger for charging the smart logistics vehicle 110, a loading space for storing or loading parts, a space for storing finished products or intermediate products, traffic lights, breakers, and a waiting space for idle smart logistics vehicles 110 can be properly arranged within the operation boundary 100.

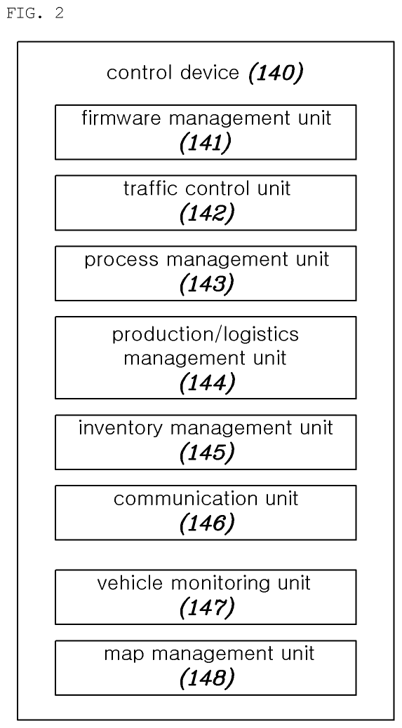

Hereinafter, a configuration of the control device 140 applicable to exemplary embodiments of the present disclosure will be described with reference to FIG. 2.

FIG. 2 is a block diagram illustrating an example of a control device configuration applicable to exemplary embodiments of the present disclosure. Each component shown in FIG. 2 may mainly show components in relation to exemplary embodiments of the present disclosure, and more or fewer components may be included in the actual implementation of the control device 140.

Referring to FIG. 2, the control device 140 may include a firmware management unit 141, a traffic control unit 142, a process management unit 143, a production/logistics management unit 144, an inventory management unit 145, a communication unit 146, a vehicle monitoring unit 147, and a map management unit 148.

The firmware management unit 141 may obtain the latest firmware of the smart logistics vehicle 110 through the communication unit 146 and transmit the same to the smart logistics vehicle 110 to perform a firmware update, thereby maintaining the firmware of the smart logistics vehicle 110 up to date.

The traffic control unit 142 may control the traffic light and the breaker on the basis of the route of the smart logistics vehicle 110, and may recalculate the route of the smart logistics vehicle 110 according to traffic.

The process management unit 143 may define a process for each product and may manage missions such as the degree of the process progress and a progress location.

The production/logistics management unit 144 may dispatch the smart logistics vehicle 110 on a mission basis.

The inventory management unit 145 may manage the location and quantity for each material, and this information may be useful for more efficient process operation, such as allowing the smart logistics vehicle 110 to depart for a destination in advance for pallet pickup or retrieval before the actual assembly or consumption of the materials is detected.

The communication unit 146 may perform communication with internal components of the operation boundary 100, such as the smart logistics vehicle 110, the production device 120, and the monitoring device 130, as well as external entities, such as a firmware update server.

The vehicle monitoring unit 147 may monitor the location, route, battery state, communication state, power train state, and the like of the individual smart logistics vehicle 110. Herein, the route may be a concept including a waypoint-based global route and a real-time local route. In addition, the battery state may include voltage, current, temperature, peak values of voltage and current, state of charge (SOC), state of health (SOH), and the like. The communication state may include information about a currently activated communication protocol (such as Wi-Fi), a connected AP, a distance to the AP, a channel in use, and the like. Further, the power train state may include a load, temperature, RPM, and the like of the drive system.

Besides, the vehicle monitoring unit 147 may identify the mission, operation mode, firmware version, and the like currently assigned to the individual smart logistics vehicle 110.

The map management unit 148 may obtain map data in the form of a grid map obtained by the AMR among the smart logistics vehicles 110 while driving inside the operation boundary 100, and provide a tool for a factory manager to edit the obtained map data. Through the editing of the map data, zones for performing one or more preset operations when the smart logistics vehicle 110 enters, virtual lanes, intersections, and entry-restricted zones may be set, but this is illustrative and is not necessarily limited thereto. In addition, the map management unit 148 may distribute the initial grid map to the rest of the smart logistics vehicles 110 other than the smart logistics vehicle 110 that obtains the corresponding map through actual driving through the communication unit 146.

Next, a smart logistics vehicle will be described with reference to FIGS. 3 and 4.

FIG. 3 is a block diagram illustrating an example of a smart logistics vehicle configuration applicable to exemplary embodiments of the present disclosure.

Referring to FIG. 3, the smart logistics vehicle 110 may include a travel unit 111, a sensing unit 112, a loading unit 113, a communication unit 114, and a control unit 115. Hereinafter, each component will be described.

The travel unit 111 may include a driving source, a wheel, a suspension, and the like, which are involved in the movement, steering, and stopping of the smart logistics vehicle 110. The driving source may utilize an electric motor supplied with power from a built-in battery (not shown). The wheel may include one or more driving wheels that receive driving force from the driving source, and a non-driving wheel that rotates by the movement of the vehicle body without receiving the driving force. Depending on the implementations, the rotation of each driving wheel may be independently controlled when a plurality of driving wheels are provided and the driving source is matched for each driving wheel. In this case, by varying the rotation directions of driving wheels different from each other, the vehicle body may be rotated to enable steering without a separate steering means. At least some of the non-driving wheels may be configured as caster-type wheels, but this is illustrative and is not necessarily limited thereto.

The sensing unit 112 may be for sensing the surrounding environment of the smart logistics vehicle 110 or a state of its own operations, and may include at least one of a 2D laser scanner (e.g., LiDAR), a 3D vision (stereo) camera, a multi-axis gyro sensor, an acceleration sensor, a wheel encoder, and a proximity sensor.

The encoder may output information for determining how much the wheel is rotated by using light emitted from a light emitting element (e. g., a photodiode). For example, the encoder may count the number of slits disposed along the circumferential direction on the wheel or the disk rotating together with the wheel for a unit time. The control unit 115 may perform odometry to estimate a displacement by analyzing the amount of location change with respect to time by using data obtained through the encoder and the gyro sensor. However, a displacement estimated on the basis of the encoder data may have an error from the actual displacement due to wheel slip or wear (a change in the wheel dynamic diameter). Therefore, when performing the odometry, the control unit 115 may perform correction for noise and error on the information collected from the wheel and gyro sensors using a predetermined algorithm (e.g., EKF: Extended Kalman Filter), thereby outputting a result that tends to be close to an actual value. Such odometry may be particularly useful when it is impossible to determine the current location (localization) using a 2D laser scanner, which will be described later.

The 2D laser scanner may scan the surrounding environment by radiating a laser beam to the surroundings through a rotating reflector and sensing a reflected and returned signal. In this case, a detection result in the form of a point cloud may be output by analyzing the intensity of the reflected signal and a time difference between radiation and reception.

The 3D vision camera may calculate a distance to the object on the basis of a parallax between two cameras spaced apart as much as a predetermined distance, that is, a pixel distance between images captured by each camera. In this case, a texture projector that projects infrared light of a predetermined pattern may be provided so that a flat object of the same color (e.g., a white wall), and the like can be detected.

In general, 2D laser scanners may be used for mapping, navigation, object recognition, etc., and 3D cameras may be used during navigation, especially for avoiding obstacles, but this is illustrative and is not necessarily limited.

The loading unit 113 may be a means for loading the item to be transported, and may be in the form of a top plate itself on the upper part of the vehicle body or a table disposed on the top plate, a lift, a turntable rotating along a vertical axis, a fork lift, a conveyor, or a combination thereof. In the case of the fork lift, it may support telescopic and tilting functions, similar to a forklift.

The communication unit 114 may communicate with other components in the operation boundary 100, such as the production device 120 and the control device 140, may support communication between the smart logistics vehicles 110, and may communicate with the charger when performing a charging mission.

The control unit 115 may be the entity that performs overall control of each of the aforementioned components 111, 112, 113, 114, and may perform a current mission, a current location, a destination determination, path planning, a control of the loading unit, and the like on the basis of the information obtained from the control device 140 through the communication unit 114.

FIG. 4 is a perspective view illustrating an example of an exterior appearance of a smart logistics vehicle applicable to exemplary embodiments of the present disclosure.

Referring to FIG. 4, an example of AMR may be illustrated as a smart logistics vehicle 110. The vehicle body may have a track-type planar shape with a long axis extending along the first axis direction as a whole. One driving wheel 111-1 may be disposed in the center portion of the vehicle body in the first axis direction, may be disposed at one side in a second axis direction, and another driving wheel (not shown) may be disposed at the other side to face one driving wheel 111-1 in the second axis direction. Such an arrangement of driving wheels may be referred to as a differential drive (DD). Although not shown in FIG. 4, two or more non-driving wheels may be disposed at a lower part of the vehicle body. In this case, when two driving wheels rotate at the same speed in the same direction, it is possible to move forward or backward along the first axis direction, and when rotating at the same speed in opposite directions, it is possible to rotate on the basis of a rotation axis extending along the third axis direction and passing through a plane center (C) of the vehicle body. In addition, the sensing unit 112 may be disposed at the front surface of the vehicle body, and the loading unit 113 may be disposed at the upper surface. The loading unit 113 may be configured to be elevated along the third axis direction, and a rack, a tray, or the like may be fixed to the upper surface through a guide 113-1.

However, the AMR form of FIG. 4 described above is illustrative, and it is obvious that the AGV may have a form similar to this or the AMR may have a form different from this.

Next, a driving process of the smart logistics vehicle 110 will be described with reference to FIG. 5.

FIG. 5 is a flowchart illustrating an example of a driving process of a smart logistics vehicle 110 applicable to exemplary embodiments of the present disclosure. In FIG. 5, it is assumed for convenience that the smart logistics vehicle 110 is an AMR capable of positioning and a local route setting.

Referring to FIG. 5, first, the AMR may obtain a ground-truth grid map through a LiDAR or the like while driving inside the operation boundary 100 (S501).

When the AMR transmits the obtained grid map to the control device 140, a grid map editing and matching process may be performed in the map management unit 148 of the control device 140 (S502). Herein, the editing process may include a process of setting the aforementioned various zones on the aforementioned grid map, a process of assigning a cost for each grid, and the like. Herein, the assignment of the cost may be performed in such a way of assigning a higher cost as moving closer to the obstacle or the entry prohibition zone so that the AMR does not move around the obstacle or to the zone not to enter. This is because the AMR selects the set of cells having the lowest cost among the waypoints as a route in setting the local route.

In addition, the map matching process may mean a process of matching coordinates between the CAD map used in the design of the operation boundary 100, the ground-truth grid map (LiDAR map), and the topology map that undergoes through the editing process.

Thereafter, the control device 140 may share the topology map with all AMRs in the factory through the communication unit 146 (S503).

A subsequent step may be a process applied to an individual AMR.

The AMR may determine the current location on the map through sensor data of the sensing unit 112 and the obtained map (S504). For example, the AMR may determine the current location by comparing the surrounding terrain obtained through the LiDAR with the map on the basis of the feature points.

The control device 140 may select a specific AMR to assign a mission, and in general, one or more waypoints determined through global path planning may be assigned to the mission. The waypoint may be defined as coordinates on the map, and information about the direction (i.e., heading), in which the AMR should be directed at, may be accompanied at the corresponding coordinates. According to the assignment of the mission, a destination may be set in the AMR (Yes in S505), and the AMR may perform local path planning between waypoints on the basis of the cost of the topology map (S506).

When the route is determined, the AMR may start driving (S507), and when an obstacle is detected through the sensing unit 112 during driving (Yes of S508), an avoidance maneuver may be performed by performing a local path searching in order to bypass the detected obstacle (S509). In some cases, the control device 140 may update the mission of the corresponding AMR according to the avoidance maneuver or according to the failure of the avoidance maneuver.

In addition, the AMR may correct the location error during moving through the aforementioned odometry technique during driving until arriving at the destination (S510).

Then, when arriving at the destination (S511), the AMR may perform a mission-based maneuver (S512). For example, the AMR may determine whether a condition for entering a specific process area is clear, retrieve an empty pallet from the destination, or drop a loaded load on the loading unit 113.

An exemplary embodiment of the present disclosure may aim to provide information about the driving route according to the mission performance of the smart logistics vehicle so that driving routes for different smart logistics vehicles having different missions to be performed do not intersect or overlap.

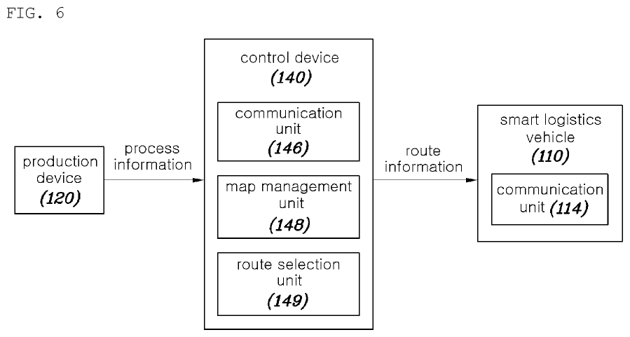

Hereinafter, a control device according to an exemplary embodiment of the present disclosure will be described with reference to FIG. 6.

FIG. 6 is a view illustrating an operation boundary equipped with a control device according to an exemplary embodiment of the present disclosure.

Referring to FIG. 6, the control device 140 according to an exemplary embodiment of the present disclosure may include a map management unit 148 for providing map information in which route selection-based scores different from each other are assigned to at least some of virtual lanes within an operation boundary 100 for each mission situation, and a route selection unit 149 for identifying the mission situation of the smart logistics vehicle 110, for determining the driving route on the basis of the map information provided by the map management unit 148 so that the smart logistics vehicle 110 can move along the virtual lane corresponding to the identified mission situation on the basis of the route selection-based score corresponding to the identified mission situation, and for transmitting the route information corresponding to the determined driving route to the smart logistics vehicle 110. In addition, the control device 140 may further include a communication unit 146 for collecting external information or transmitting information generated within the control device 140 to the outside.

In FIG. 6, one control device 140 and one smart logistics vehicle 110 are described for convenience of explanation, but it should be understood that this applies equally when a plurality of smart logistics vehicles or a plurality of control units are provided.

Hereinafter, each component included in the control device 140 will be described in detail.

The virtual lane along which a smart logistics vehicle 110 can move when performing a mission may be formed on the operation boundary 100. Also, the map management unit 148 may assign the route selection-based score to at least some virtual lanes among the plurality of virtual lanes formed on the operation boundary 100. The route selection-based score may refer to a cost assigned for each unit region or unit cell within the operation boundary for each mission situation.

As described above in FIG. 5, conventionally, the cost may be assigned to the virtual lane and the smart logistics vehicle 110 may move along the virtual lane with a lower cost between a virtual lane with a high cost and a virtual lane with a low cost. In this case, when a driving route is formed on the basis of such a virtual lane where only the possibility of movement or directionality due to the assigned cost is set for the virtual lane, there may occur points or regions where the driving route intersect or overlap. When the smart logistics vehicle 110 moves along such a driving route, there may be a problem in that a collision occurs between the smart logistics vehicles 110 at the intersecting or overlapping points or regions, or in that an avoidance driving should be performed in order to prevent the collision from occurring.

In order to solve this problem, the map management unit 148 according to an exemplary embodiment of the present disclosure may provide map information in which route selection-based scores different from each other are assigned to at least some of virtual lanes in the operation boundary 100 for each mission situation. In this case, the mission situation of the smart logistics vehicle 110 may include at least one of information about a mission to be performed by the smart logistics vehicle 110, information about a loading state of the smart logistics vehicle 110, and information about a type of the smart logistics vehicle 110. The information about the mission to be performed may include at least one of a supply mission, a retrieval mission, and a charging mission to be performed by the smart logistics vehicle 110, and the information about the loading state of the smart logistics vehicle 110 may include at least one of information about whether the smart logistics vehicle 110 is loaded with a loaded product and information about the loaded product loaded on the smart logistics vehicle 110. The information about the type of the smart logistics vehicle 110 may include information about the intended use (e.g., performing a logistics job, performing a parking job, performing a cleaning job, etc.) of the smart logistics vehicle 110.

That is, the map management unit 148 may provide map information where virtual lanes movable for each mission situation of the smart logistics vehicle 110 are distinguished with respect to at least some virtual lanes. For example, the map management unit 148 may assign a low route selection-based score for a supply mission and assign a high route selection-based score for a retrieval mission with respect to a virtual lane, thereby providing map information SO that the corresponding virtual lane can be used only for a supply mission. To this end, the route selection-based score may be assigned as a fixed value for each virtual lane or may be assigned as a value that changes periodically according to the mission situation.

However, this is illustrative and is not necessarily limited thereto. For example, the map management unit 148 may provide preset map information by presetting map information in which the route selection-based scores different from each other are assigned to at least some virtual lanes within the operation boundary 100 for each mission situation, and the map management unit 148 may generate map information in which the route selection-based scores different from each other are assigned to at least some virtual lanes within the operation boundary 100 for each mission situation, and provide the generated map information.

The route selection unit 149 may identify the mission situation of the smart logistics vehicle 110 and determine the driving route of the smart logistics vehicle 110 on the basis of the mission situation identified on the basis of the map information provided by the map management unit 148.

Specifically, the route selection unit 149 may collect process information of the operation boundary 100. The process information may include at least one of the process state information and the logistics request information of the operation boundary 100, and the route selection unit 149 may collect the process information provided from the production device 120 provided in the operation boundary 100. In this case, the control device 140 may collect the process information provided from the production device 120 through the communication unit 146 and provide the process information collected from the communication unit 146 to the route selection unit 149, such that the route selection unit 149 can collect the provided process information again. However, this is illustrative, and is not necessarily limited thereto.

Also, the route selection unit 149 may determine a mission situation for the smart logistics vehicle 110 on the basis of the collected process information, and may identify the determined mission situation. For example, the route selection unit 149 may determine a mission situation such as a supply mission and a retrieval mission to be performed by the smart logistics vehicle 110 on the basis of the collected process information.

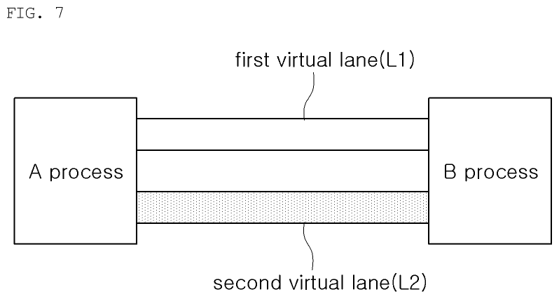

The route selection unit 149 may identify the mission situation and determine the driving route so as to move along the virtual lane corresponding to the mission situation identified on the basis of the route selection-based score corresponding to the mission situation identified on the basis of the map information provided by the map management unit 148. To determine the driving route will be described with reference to FIGS. 7 to 10.

FIGS. 7 to 10 are views illustrating determination of a driving route of a smart logistics vehicle according to an exemplary embodiment of the present disclosure.

First, referring to FIG. 7, it is assumed that two arbitrary process zones, i.e., process A and process B, are formed within the operation boundary 100. Also, a plurality of virtual lanes (L1, L2) connecting the two processes may be formed between the A process and the B process. The map management unit 148 may provide map information where the route selection-based score is assigned to each of the plurality of virtual lanes (L1, L2) for each mission situation. For example, a first virtual lane (L1) may be assigned the route selection-based score of 3 for a supply mission, the route selection-based score of 6 for a retrieval mission, and the route selection-based score of 5 for a simple move mission. Also, the second virtual lane (L2) may be assigned the route selection-based score of 5 for the supply mission, the route selection-based score of 2 for the retrieval mission, and the route selection-based score of 6 for the simple movement mission.

When material supply from the A process to the B process is required on the basis of the collected process information, the route selection unit 149 may determine and identify the mission situation so that the smart logistics vehicle 110 performs the supply mission from the A process to the B process. Also, the route selection unit 149 may determine the driving route to move along the virtual lane corresponding to the mission situation identified on the basis of the route selection-based score corresponding to the mission situation identified on the basis of the map information provided by the map management unit 148. For example, when the mission situation is a supply mission from the A process to the B process, the route selection unit 149 may determine the route selection-based score assigned to correspond to the supply mission for each of the plurality of virtual lanes (L1, L2) on the basis of the map information. Previously, the route selection-based score for the supply mission assigned to the first virtual lane (L1) may be 3, and the route selection-based score for the supply mission assigned to the second virtual lane (L2) may be 5. The route selection unit 149 may determine the driving route so that the smart logistics vehicle 110 moves along the first virtual lane (L1) having a low score on the basis of the two route selection-based scores.

Also, the route selection unit 149 may select a departure point and a destination corresponding to the identified mission situation in the operation boundary 100, and determine the driving route connecting the departure point and destination selected on the basis of the map information.

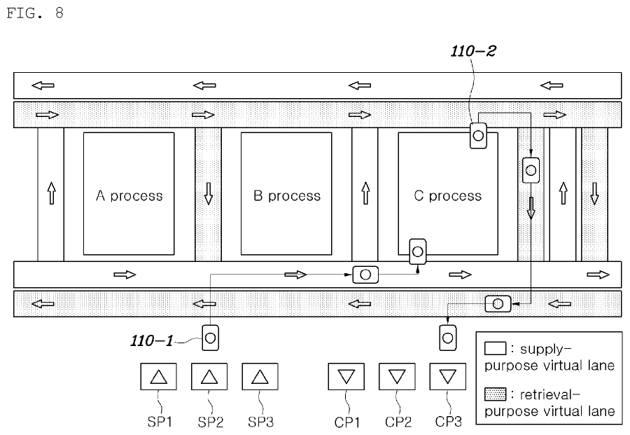

As shown in FIG. 8, a plurality of virtual lanes may be formed within the operation boundary 100, and the route selection-based score for each mission situation, particularly, a supply mission and a retrieval mission, may be assigned to each of the plurality of virtual lanes by the map management unit 148. For example, a supply-purpose virtual lane may refer to a virtual lane in which the route selection-based score according to a supply mission is assigned low, and a retrieval-purpose virtual lane may refer to a virtual lane in which the route selection-based score according to a retrieval mission is assigned low. However, this is illustrative and is not necessarily limited thereto. The map management unit 148 may provide map information set in this manner to the route selection unit 149.

Also, referring to FIG. 8, the route selection unit 149 may select a departure point and a destination corresponding to the identified mission situation within the operation boundary 100. For example, a plurality of processes (process A, process B, and process C) may be formed within the operation boundary 100 and, when the identified mission situation is a parts supply mission due to a parts request from the C process, the route selection unit 149 may select one of the plurality of supply ports (SP1, SP2, SP3) provided within the operation boundary 100 as the departure point (e.g., SP2), and select the C process as the destination.

When the departure point and destination are selected, the route selection unit 149 may determine the driving route connecting the departure point and the destination so as to move along the virtual lane corresponding to the mission situation identified on the basis of the route selection-based score corresponding to the mission situation identified on the basis of the map information. For example, the route selection unit 149 may determine the driving route connecting the supply port (SP2) as a departure point and the C process as a destination along a supply-purpose virtual lane where the low route selection-based score is assigned for the parts supply mission of a first smart logistics vehicle (110-1) that performs the parts supply mission.

On the other hand, when the identified mission situation is a retrieval mission due to a request to retrieve empty pallets from the C process, the route selection unit 149 may select the C process as a departure point and select one retrieval port (e.g., CP3) of a plurality of retrieval ports (CP1, CP2, CP3) provided in the operation boundary 100 as a destination. When a departure point and a destination are selected, the route selection unit 149 may determine the driving route connecting the C process as the departure point and the retrieval port (CP3) as the destination for a second smart logistics vehicle 110-2 to perform the retrieval mission so as to move along a retrieval-purpose virtual lane where the low route selection-based score is assigned for the retrieval mission which is a mission situation identified on the basis of the map information.

In addition, the route selection unit 149 may determine the driving route connecting the departure point and the destination by further considering the state information of each of the selected departure point and destination. For example, the route selection unit 149 may determine the driving route connecting the departure point and the destination by further considering the state information of each of the plurality of supply ports (SP1, SP2, SP3), the state information of each of the plurality of retrieval ports (CP1, CP2, CP3), and the state information of each of the plurality of processes (A process, B process, and C process).

In this way, when the first smart logistics vehicle 110-1 performing the supply mission and the second smart logistics vehicle 110-2 performing the retrieval mission coexist by determining the t driving route according to the mission situation to be performed by the smart logistics vehicle 110, it is possible to prevent the driving route of the first smart logistics vehicle 110-1 and the driving route of the second smart logistics vehicle 110-2 from overlapping or intersecting.

In addition, the route selection unit 149 may determine the driving route on the basis of the map information where information about whether at least some virtual lanes are activated for each mission situation is further reflected.

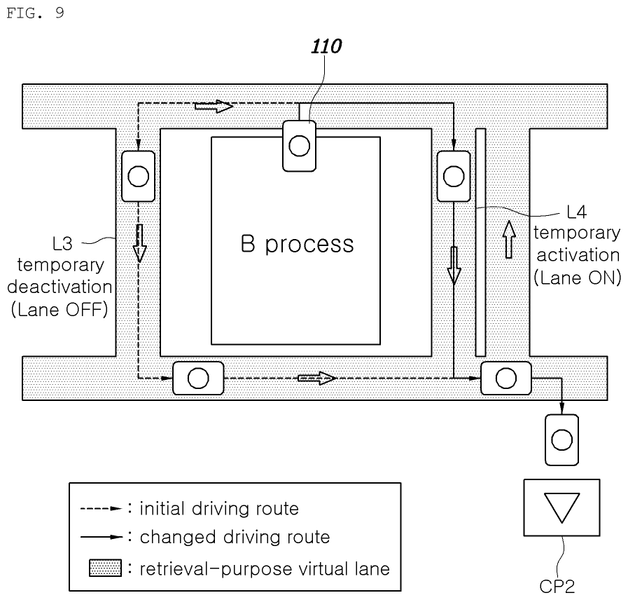

Referring to FIG. 9, the plurality of virtual lanes may be formed around an arbitrary process zone (e.g., process B) existing in the operation boundary 100, and each of the plurality of virtual lanes may be assigned the route selection-based score according to a mission situation, particularly a supply mission and a retrieval mission, by the map management unit 148. In FIG. 9, it is assumed that the plurality of virtual lanes formed around the B process according to an exemplary embodiment are the retrieval-purpose virtual lanes in which the route selection-based score corresponding to a retrieval mission is assigned lower than a route selection-based score corresponding to a supply mission.

As described above, the map management unit 148 may provide map information in which the route selection-based scores different from each other are assigned to at least some virtual lanes within the operation boundary 100 according to mission situations. In this case, whether to activate for each mission situation may be set to at least some virtual lanes in order to shorten a driving route or a movement time. The map management unit 148 may update the map information so that information about whether to activate for each mission situation is further reflected on at least some virtual lanes in the existing map information, and may provide the updated map information. Also, the route selection unit 149 may determine the driving route for each mission situation on the basis of the updated map information.

For example, when information about the activation of a virtual lane (L3) is included in the initial map information provided by the map management unit 148, the route selection unit 149 may determine an initial driving route including the virtual lane (L3) activated to move along the virtual lane corresponding to the mission situation on the basis of the route selection-based score corresponding to the mission situation, which is a retrieval mission of the smart logistics vehicle 110 from the B process to the retrieval port (CP2) on the basis of the initial map information. The smart logistics vehicle 110 may be driven on the basis of the initial driving route determined by the route selection unit 149, but in order to shorten the mission performance time, the map management unit 148 may further collect information about whether another unused virtual lane corresponding to the identified mission situation is activated. For example, the map management unit 148 may update the map information so that information about the virtual lane (L4), which can be temporarily activated corresponding to the retrieval mission identified by the route selection unit 149, can be further reflected, and may provide the updated map information to the route selection unit 149.

The route selection unit 149 may determine the driving route, which is changed differently from the initial driving route from the B process to the retrieval port (CP2), on the basis of the map information where information about the temporary activation of the virtual lane (L4) is updated. The route selection unit 149 may determine the driving route, where the route is changed to be shorter than the initial driving route, on the basis of the map information where information about whether to activate at least some virtual lanes is further reflected. However, as described above, it is described that whether to activate the virtual lane is set in order to shorten the driving route or movement time, but this is illustrative and is not necessarily limited thereto. For example, whether to activate the virtual lane may be set in order to prevent overlapping or intersecting when determining the driving route in consideration of the mission situation, or whether to activate according to whether the driving is possible may be set by determining the current state of the virtual lane on the basis of the process information provided by the production device 120.

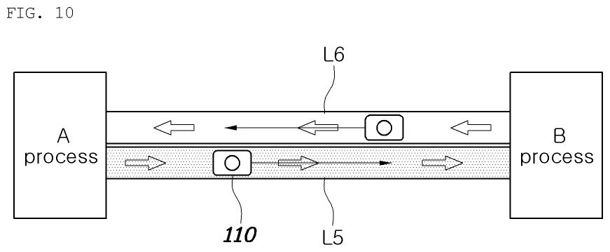

Meanwhile, referring to FIG. 10, when there are two adjacent virtual lanes (L5, L6) connecting the A process and the B process formed in the operation boundary 100, the route selection-based score corresponding to the mission situation for two adjacent virtual lanes may be fixedly applied. For example, for the mission situation of moving back and forth between the A process and the B process, the route selection unit 149 may preferentially determine the driving route including the virtual lane (L5) while corresponding to the mission situation in which the A process is the departure point and the B process is the destination. Also, the route selection unit 149 may determine the driving route including the virtual lane (L5) while corresponding to the mission situation in which the B process is the departure point and the A process is the destination. However, in this case, in order to include the virtual lane (L5) again in the driving route, there may be a hassle of changing the route selection-based score assigned to the virtual lane (L5). Therefore, when there are the adjacent virtual lanes (L5, L6) connecting the two processes (process A and process B), the map management unit 148 may fixedly apply the route selection-based score corresponding to the mission situation for the two adjacent virtual lanes. For this reason, the route selection unit 149 may include only the virtual lane (L5) as the driving route when moving from the A process to the B process at the time of determining the driving route, and may include only the virtual lane (L6) as the driving route when moving from the B process to the A process. That is, the map management unit 148 may fixedly assign the route selection-based score to at least some virtual lanes for each mission situation of the smart logistics vehicle 110, on the basis of which the route selection unit 149 may determine the driving route so that the virtual lanes are distinguished for each mission situation of the smart logistics vehicle 110.

Referring back to FIG. 6, when the driving route is determined by the route selection unit 149, the route selection unit 149 may transmit the route information corresponding to the determined driving route to the smart logistics vehicle 110 performing the identified mission situation. In particular, the route selection unit 149 may select a plurality of waypoints corresponding to the driving route on the basis of the determined driving route, and transmit the route information including information about the plurality of selected waypoints to the smart logistics vehicle 110. In this case, the route selection unit 149 may transmit the route information to the communication unit 146 and may transmit the same to the smart logistics vehicle 110 through the communication unit 146. The smart logistics vehicle 110 performing the mission situation identified by the route selection unit 149 may receive the route information corresponding to the driving route determined by the route selection unit 149 through the communication unit 114.

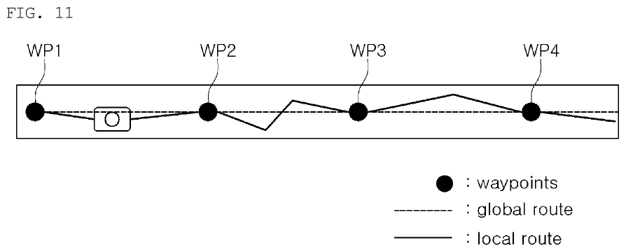

By the route selection unit 149 transmitting the route information including information about the plurality of waypoints to the smart logistics vehicle 110, the smart logistics vehicle 110 may determine the route selection-based score assigned to at least one virtual lane formed between the waypoints on the basis of the route information and may move between waypoints. This will be described in detail with reference to FIG. 11.

FIG. 11 is a view illustrating a smart logistics vehicle driving on the basis of route information according to an exemplary embodiment of the present disclosure.

Referring to FIG. 11, the route selection unit 149 may select the plurality of waypoints (WP1, WP2, WP3, WP4) corresponding to the determined driving route, and the plurality of waypoints (WP1, WP2, WP3, WP4) may be present on any one virtual lane. However, this is illustrative and may be shown as being on a single virtual lane for illustrative purposes only, and may not be necessarily limited thereto. For example, the plurality of waypoints (WP1, WP2, WP3, WP4) may be present on the plurality of virtual lanes.

The route selection unit 149 may transmit the route information including information about the plurality of selected waypoints to the smart logistics vehicle 110, and the smart logistics vehicle 110 may drive according to a mission situation on the basis of the route information including information about the plurality of waypoints. However, when the smart logistics vehicle 110 drives, the smart logistics vehicle 110 may drive while updating the state of the currently driving virtual lane in real time through the separately equipped sensing unit 112. Accordingly, even when the route selection unit 149 provides the smart logistics vehicle 110 with a global route connecting a plurality of waypoints (WP1, WP2, WP3, WP4) as a driving route, the smart logistics vehicle 110 can drive to form a local route in the region between the waypoints rather than the global route through real-time sensing of the sensing unit 112. In addition, when at least one virtual lane is formed between the plurality of waypoints (WP1, WP2, WP3, WP4), the smart logistics vehicle 110 may directly determine the route selection-based score assigned to the at least one virtual lane and move between the waypoints along the virtual lane having the route selection-based score corresponding to the current mission situation.

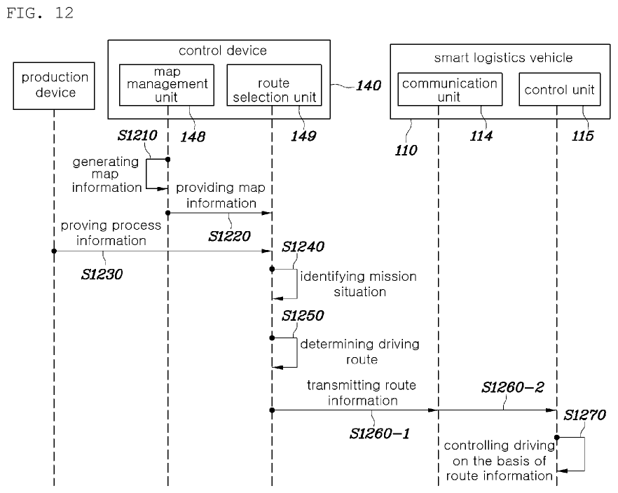

Hereinafter, a smart logistics vehicle control method according to an exemplary embodiment of the present disclosure will be described with reference to FIG. 12 on the basis of the configuration of the control device 140 described above in FIG. 6.

FIG. 12 is a view illustrating a smart logistics vehicle control method according to an exemplary embodiment of the present disclosure.

Referring to FIG. 12, the map management unit 148 may generate map information where the route selection-based scores different from each other are assigned to at least some virtual lanes within the operation boundary 100 for each mission situation (S1210). Also, the map management unit 148 may provide the generated map information to the route selection unit 149 (S1220). However, the S1210 step may be omitted according to exemplary embodiments, and when omitted, the map management unit 148 may provide the preset map information to the route selection unit 149.

Also, the route selection unit 149 may receive and collect process information of the operation boundary 100 from the production device 120 (S1230). The route selection unit 149 may identify the mission situation of the smart logistics vehicle 110 on the basis of the collected process information (S1240), and may determine the driving route to move along the virtual lane corresponding to the mission situation identified on the basis of the route selection-based score corresponding to the mission situation identified on the basis of the map information provided by the map management unit 148 (S1250). The process of determining the driving route is described in detail with reference to FIGS. 6 and 7 to 10, and thus further explanation will be omitted.

The route selection unit 149 may generate route information corresponding to the determined driving route, and may transmit the generated route information to the communication unit 114 of the smart logistics vehicle 110 (S1260-1). The communication unit 114 of the smart logistics vehicle 110 may transmit the route information received from the route selection unit 149 to the control unit 115 (S1260-2), and the control unit 115 may control the driving of the smart logistics vehicle 110 according to the mission situation on the basis of the received route information (S1270).

As described above, a smart logistics vehicle control method and a control device of the present disclosure can determine driving routes so that a smart logistics vehicle moves along a virtual lane corresponding to the identified mission situation on the basis of a route selection-based score corresponding to the identified mission situation, thereby preventing driving routes from intersecting or overlapping and improving the mobility of the smart logistics vehicle.

In addition, it is possible to easily identify the flow of logistics within an operation boundary by determining the driving route for each mission situation of the smart logistics vehicle.

Although shown and described with respect to a specific exemplary embodiment of the present disclosure, it will be apparent to those skilled in the art that the present disclosure may be modified and changed in various ways without departing from the technical idea of the present disclosure provided by the following claims.

The present disclosure described above may be implemented as computer-readable code on a medium on which a program is recorded. The computer-readable medium may include all types of recording devices in which data readable by a computer system is stored. Examples of computer-readable medium may include hard disk drives (HDDs), solid state disks (SSDs), silicon disk drives (SDDs), ROMS, RAMS, CD-ROMs, magnetic tapes, floppy disks, optical data storage devices, and the like. Therefore, the above detailed description should not be interpreted in all respects and should be considered as illustrative. The scope of the present disclosure should be determined by reasonable interpretation of the appended claims, and all changes within the equivalent scope of the present disclosure may be included in the scope of the present disclosure.

### DESCRIPTION OF REFERENCE NUMERALS

100: operation boundary
110: smart logistics vehicle
120: production device
130: monitoring device
140: control device

1. A smart logistics vehicle control method, the method comprising:
identifying a mission situation of a smart logistics vehicle;
determining a driving route based on map information, where route selection-based scores different from each other are assigned to at least some of virtual lanes within an operation boundary for each mission situation, such that the smart logistics vehicle moves along the virtual lane corresponding to the identified mission situation based on the route selection-based score corresponding to the identified mission situation; and
transmitting route information corresponding to the determined driving route to the smart logistics vehicle.

2. The method of claim 1, wherein the mission situation comprises at least one of information about a mission to be performed by the smart logistics vehicle, information about a loading state of the smart logistics vehicle, and information about a type of the smart logistics vehicle.

3. The method of claim 2, wherein the information about the loading state comprises at least one of information about whether the smart logistics vehicle is loaded and information about loading items loaded on the smart logistics vehicle.

4. The method of claim 1, wherein the route selection-based score refers to a cost assigned to each unit region or unit cell within the operation boundary for each mission situation.

5. The method of claim 1, wherein the identifying comprises:
collecting process information of the operation boundary; and
identifying the mission situation of the smart logistics vehicle determined based on the collected process information.

6. The method of claim 5, wherein the process information comprises at least one of process state information and logistics request information of the operation boundary.

7. The method of claim 1, wherein the determining comprises:
selecting a departure point and a destination within the operation boundary corresponding to the identified mission situation; and
determining the driving route connecting the selected departure point and destination based on the map information.

8. The method of claim 7, wherein the determining determines the driving route connecting the departure point and destination by further considering state information of each of the selected departure point and destination.

9. The method of claim 1, wherein the determining comprises determining the driving route based on the map information that further reflects information about whether at least some of the virtual lanes are activated for each mission situation in the map information.

10. The method of claim 1, wherein the transmitting comprises:
selecting a plurality of waypoints corresponding to the driving route based on the determined driving route; and
transmitting the route information including information about the plurality of selected waypoints to the smart logistics vehicle.

11. The method of claim 10, wherein the transmitting comprises transmitting the route information including the information about the plurality of waypoints to the smart logistics vehicle, such that the smart logistics vehicle determines the route selection-based score assigned to at least one virtual lane formed between the waypoints based on the route information and moves between the waypoints.

12. A control device, the device comprising:
a map management unit for providing map information, where route selection-based scores different from each other are assigned to at least some of virtual lanes within an operation boundary for each mission situation; and
a route selection unit for identifying the mission situation of a smart logistics vehicle, for determining a driving route based on the map information provided by the map management unit, such that the smart logistics vehicle moves along the virtual lane corresponding to the identified mission situation based on the route selection-based score corresponding to the identified mission situation, and for transmitting route information corresponding to the determined driving route to the smart logistics vehicle.

13. The device of claim 12, wherein the route selection unit collects process information of the operation boundary and identifies the mission situation of the smart logistics vehicle determined based on the collected process information.

14. The device of claim 12, wherein the route selection unit selects a departure point and a destination within the operation boundary corresponding to the identified mission situation, and determines the driving route connecting the selected departure point and destination based on the map information.

15. The device of claim 14, wherein the route selection unit determines the driving route connecting the departure point and destination by further considering state information of each of the selected departure point and destination.

16. The device of claim 12, wherein the route selection unit determines the driving route based on the map information that further reflects information about whether at least some of the virtual lanes are activated for each mission situation in the map information.

17. The device of claim 12, wherein the route selection unit selects a plurality of waypoints corresponding to the driving route based on the determined driving route and transmits the route information including information about the plurality of selected waypoints to the smart logistics vehicle.

18. The device of claim 17, wherein the route selection unit transmits the route information including the information about the plurality of waypoints to the smart logistics vehicle, such that the smart logistics vehicle determines the route selection-based score assigned to at least one virtual lane formed between the waypoints based on the route information and moves between the waypoints.
